(19) United States
(12) Patent Application Publication
(10) Pub. No.: US 2005/0135397 A1
(43) Pub. Date: Jun. 23, 2005

(54) Buffer replenishing

(76) Inventors: Adrian C. Hoban, Castlebar (IE); Mark G. Burkley, Limerick (IE); Mehdi M. Hassane, Limerick (IE)

Correspondence Address: FISH & RICHARDSON, PC, 12390 EL CAMINO REAL, SAN DIEGO, CA, 92130-2081, US

(21) Appl. No.: 10/742,737

(22) Filed: Dec. 18, 2003

(51) Int. Cl. G06F 12/00

(52) U.S. Cl. 370/428

(57) ABSTRACT

A method of replenishing buffers includes assigning a buffer to hardware via a low priority task, storing data in the buffer via the hardware, and passing the data from the buffer to a high priority task. The high priority task takes precedence over the low priority task in terms of processing resources. The method also includes processing the data via the high priority task.

### TECHNICAL FIELD

This patent application relates generally to replenishing software buffers into hardware queues and, more particularly, to replenishing buffers using a low priority software task.

### BACKGROUND

Devices, such as network processors, include buffers to receive data (“receive buffers”) and buffers to transmit data (“transmit buffers”). The data may be received from an external source, e.g., a node of a network, and may be transmitted to an external destination, e.g., another node of the network. Data from the receive buffers is passed to software running on the device, which processes the data prior to subsequent transmission from the device.

### DESCRIPTION OF THE DRAWINGS

FIG. 1 is a block diagram of hardware and software included in a network processor.

FIG. 2 is a flowchart showing a buffer replenishing process performed in the network processor.

FIG. 3 is a block diagram of a router that may include the network processor and perform the process.

### DESCRIPTION

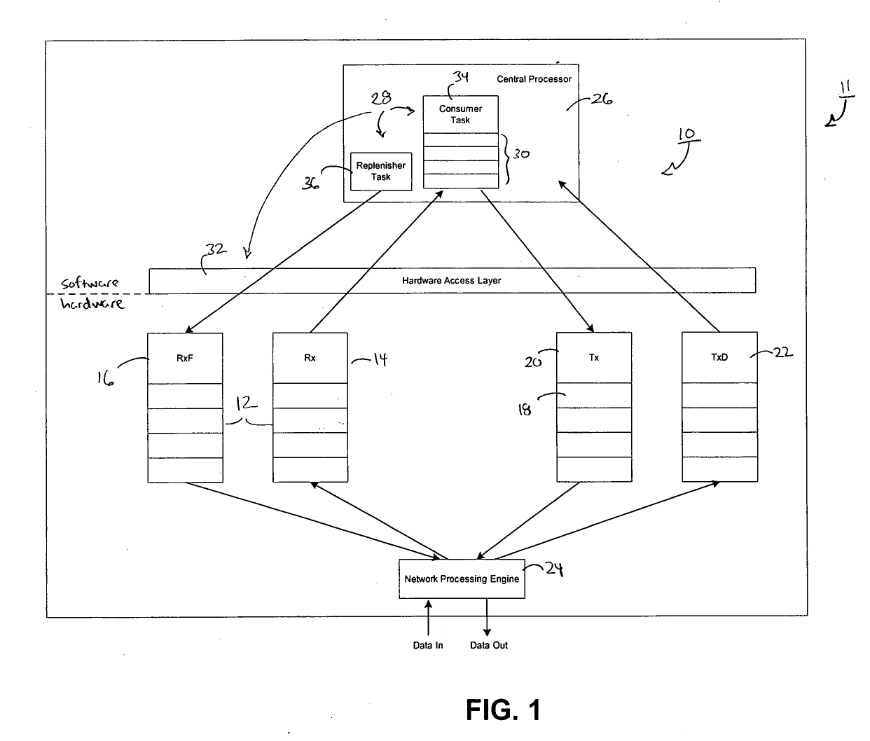

FIG. 1 is a block diagram of circuitry 10 for use in the buffer replenishing process described herein. In this embodiment, circuitry 10 is part of a network processor 11.

Generally speaking, a network processor is a processing device that handles tasks, such as processing data packets, data streams, or network objects. Functions of a network processor may be categorized into physical-layer functions, switching and fabric-control functions, packet-processing functions, and system-control functions. In some cases the packet-processing functions can be subdivided into network-layer packet processing and higher-layer packet processing.

The physical-layer functions handle signaling over network media connections, such as a 100BaseT Ethernet port, an optical fiber connection, or a coaxial T3 connection. Network processors are responsible for converting data packets into digital signals transmitted over physical media.

The packet-processing functions handle processing of all network protocols. Thus, a packet containing instructions on allocating a stream for continuous guaranteed delivery is handled at this level. System-control or host-processing functions handle management of all the other components of a device, such as power management, peripheral device control, console port management, etc.

The switching and fabric-control functions are responsible for directing traffic inside the network processor. These functions direct the data from an input port to an appropriate output port toward a destination. These functions also handle operations such as queuing data in receive and transmit buffers that correspond to the ports.

In FIG. 1, receive buffers 12 are designated memory areas that receive data from an external source, such as a network or other device. The data may be formatted as network packets containing data, such as voice, images, text, video, and the like. Receive buffers 12 together comprise a receive queue (Rx 14) that stores received data. Queue 16 corresponds to addresses of memory on which data can be received. These addresses are “free” in the sense that they have not yet been assigned to be receive buffers in Rx 14. Hence, these addresses are referred to as the Rx free queue, or simply RxF.

Transmit buffers 18 are designated memory areas that receive data to be transmitted to a destination, such as a network or other device. Transmit buffers 18 together comprise a transmit queue (Tx 20) that stores data prior to transmission. Transmit Done Queue (TxD 22) contains buffers that no longer store data and that are to be reassigned.

Circuitry 10 also includes a network processing engine 24. Network processing engine 24 is a dedicated hardware entity that receives, routes and in some cases processes, data packets received from an external source. Network processing engine 24 also outputs data packets from Tx 20. The operation of network processing engine 24 is described below.

Network processor 11 also includes a central processor 26. Central processor 26 is programmed with software 28 to perform the functions described herein. This software may include, but is not limited to, a software stack 30, a hardware access layer 32, a consumer task 34, and a replenisher task 36. The operation of software 28 is described in more detail below.

Consumer task 34 is a software thread that runs on central processor 26. Consumer task 34 processes data that is received by network processing engine 24. Hardware access layer 32 is a low-level software routine that enables communication between hardware and software on the device.

Software stack 30 contains software used to process the data for input/output. For example, software stack 30 may include the standard open system interconnection (OSI) protocol stack for processing data packets received from a Transmission Control Protocol/Internet Protocol (TCP/IP) network. The standard OSI stack defines a networking framework for implementing protocols in seven layers. Control may be passed from one layer to the next, starting at the bottom layer and proceeding up to the application layer (in this case, in the context of consumer task 34), and vice versa for output of processed data.

Any type of data processing program may run consumer task 34 including, but not limited to a routing program, voice recognition software, IP telephony applications, etc. Consumer task 34 outputs processed data to Tx 20. From there, the data is output to its destination, e.g., a network, device or the like, by network processing engine 24.

Replenisher task 36 is a software thread running on central processor 26. Replenisher task 36 assigns addresses (i.e., software buffers) to a hardware queue, i.e., RxF 16, for use by network processing engine 24. A pointer indicates the assigned addresses. Replenisher task 36 may assign a number of buffers that is appropriate under the circumstances, as described below. If replenisher task 36 were unable to run, network processing engine 24 would be “starved” of buffers to receive data and would, therefore, drop data.

Consumer task 34 may be designated as a “high priority” application, meaning that consumer task 34 takes precedence over other software, most notably replenisher task 36. In more detail, consumer task 34 is given access to resources (e.g., processing cycles) of central processor 26 before (i.e., ahead of) other applications. Replenisher task 36 may be designated as a “low priority” application, meaning that replenisher task 36 is lower priority (at least than consumer task 34) vis-à-vis access to resources of central processor 26. Other software running in central processor 26 may also be assigned priorities, although this is not necessary.

A high priority application, such as consumer task 34, may be given access to processor resources (e.g., cycles of central processor) at the expense of a low priority application, such as replenisher task 36, thereby limiting the low priority application's access to those resources. If a high priority application is sufficiently busy (e.g., has a large amount of data to process), the low priority application may not have a chance to run (or may run at a reduced rate) for lack of processor resources, at least until the high priority application is finished (or is no longer as busy).

The foregoing arrangement acts to “throttle” data passing through network processor 11. That is, data passing through network processor 11 is regulated by the operation of high priority consumer task 34 and low priority replenisher task 36, as described below.

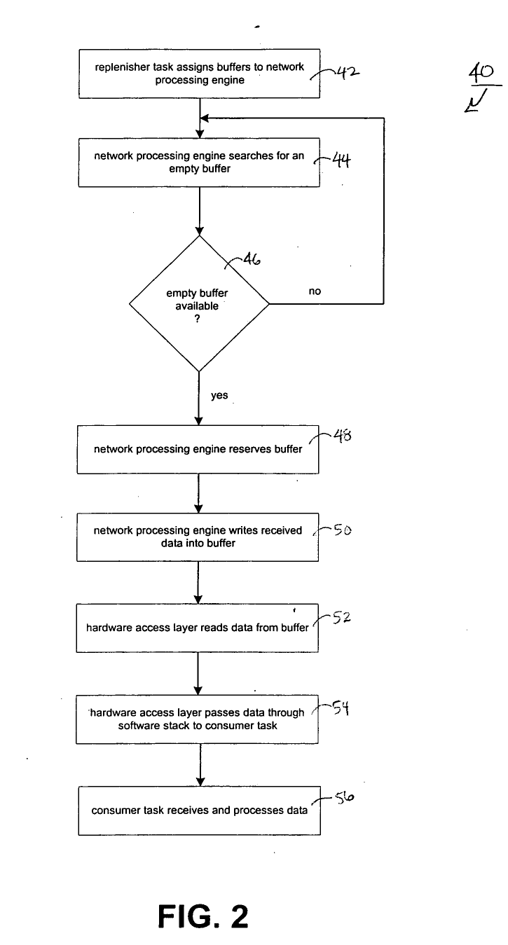

Referring to FIG. 2 (process 40), replenisher task 36 assigns (42) buffers to network processing engine 24. In particular, replenisher task 36 obtains an empty buffer (i.e., address space) from an address pool (referred to herein as “mbuf”) in memory. The address pool may be designated beforehand or it may be determined simply by locating memory locations that are available for use as buffer space. Replenisher task 36 assigns the empty buffer to RxF 16.

The number of buffers that may be assigned may be pre-set in replenisher task 36 or may be determined dynamically based, e.g., on the speed of central processor 26, the number of routines running, etc. The assigned buffers receive data from an external source, such as another device (e.g., on a same, or different, network), as described below.

Upon receiving data from an external source, network processing engine searches (44) RxF 16 for an empty buffer, i.e., an area of memory that does not already contain received data. If there is an empty buffer available (46), network processing engine 24 removes the buffer from RxF 16 by reserving (48) the buffer's memory address space. In this embodiment, network processing engine 24 only reserves one receive buffer at a time, although in other embodiments, more than one buffer may be reserved at time. If there is no empty buffer available (46), network processing engine 24 continues searching (e.g., polling) (44) RxF 16 for an empty buffer until one is located. After network processing engine has reserved an empty buffer in RxF 16, network processing engine writes (50) received data into that empty buffer, thereby making the buffer part of Rx 14.

Hardware access layer 32 reads (52) the data from the buffer in Rx 14. Hardware access layer 32 determines that the buffer (and thus the data) is there either via polling or an interrupt call-back mechanism. Once the data is read from the buffer, the buffer may be added to Tx 20. After data is output from the buffer in Tx20, that same buffer may be moved to TxD 22 (see below), and then released. To release the buffer, network processing engine reassigns the buffer's memory space to the address pool used to populate RxF.

Hardware access layer 32 passes (54) the read data through software stack 30 to consumer task 34, which resides at “the top” of the stack. Software stack 30 is running in the context of consumer task 34. Consumer task 34 receives the data and processes (56) the data. Any type of processing may be performed. Since consumer task 34 is a high priority task, consumer task 34 is allowed (by central processor 26) to consume as many processor resources as are available (with constraints, such as resources allocated to other routines needed for operation of network processor 11).

As consumer task 34 consumes more and more processor resources (i.e., by processing data read from Rx 14), fewer processor resources are available to run replenisher task 36. As a result, replenisher task 36 will slow, resulting in the allocation of fewer buffers to Rx 14. At some point, consumer task 34 may stop running due to a lack of sufficient processor resources. Meanwhile, consumer task 34 continues to obtain data from buffers in Rx 14. However, because replenisher task is not operating, new buffers are not being replenished and, thus, the data being transferred to consumer task 34 is not being replaced with new data. As a result, at some point, consumer task 34 will have no (or at least a lesser amount of) data to process (e.g., because no data is left in Rx 14). This “frees up” processor resources, allowing low priority routines, in particular, replenisher task 36, to begin operating again.

After replenisher task 36 beings operating again, replenisher task 36 begins replenishing buffers for (i.e., assigning buffers to) RxF 16. As more and more buffers are assigned to RxF, network processing engine 24 is able to store more data in Rx 14, thereby making more data available for consumer task 34 to process. As a result, consumer task 34 consumes more processor resources, thereby slowing, and eventually stopping, operation of replenisher task 36. This process continues throughout operation of network processor 11. Consumer task 34 and replenisher task 36 thus self-regulate, resulting in less data loss. Heretofore, disparities in the operation of consumer task 34 and the assignment of buffers could result in data loss and, thus, poor transmission of data. Typically, data was not dropped until it had passed through some, if not most, of the software stack, thereby consuming processing cycles needlessly. By contrast, if data is dropped via process 40, that data is dropped before being passed through the software stack, thereby reducing waste of processing cycles.

The number of buffers assigned by replenisher task 36 may be “tuned”. That is, the number of buffers allocated by replenisher task 36 may be set, e.g., to accommodate faster or slower data transfer rates. The tuning may be implemented by “hard-coding” the number of buffers in replenisher task 36 or a user may be prompted for an input that can set the number of buffers that are to be set by replenisher task 36. By way of example, system designers that want to give priority to Ethernet traffic can simply ensure that Ethernet queues are filled during each pass of the replenishing task, while only replenishing a limited number of other queues.

Data processed by consumer task may be destined for an output interface. In this case, network processing engine 24 assigns buffers from Rx 14 to Tx 20, as described above. Hardware access layer 32 locates a transmit buffer in Tx 20 and sends data from software stack 30 to that transmit buffer. Network processing engine 24 identifies the transmit buffer in which data has been stored (e.g., by examining the buffer's contents) and sends the data it contains out on a hardware interface. Network processing engine 24 then assigns the transmit buffer from which data was output to TxD 22. Thereafter, hardware access layer 32 removes the transmit buffer from TxD 22. That is, hardware access layer 32 determines that a buffer is in TxD 22 either via a polling or interrupt call-back mechanism and frees the buffer, e.g., by returning it to the address pool from which the buffer originated (e.g., for reassignment).

Circuitry 10 and process 40 may be implemented in any data transfer and processing device or system. In one embodiment, a network processor containing circuitry 10 and process 40 is used in a router that receives Ethernet data and outputs asynchronous transfer mode (ATM) data on an asymmetric digital subscriber (ADSL) medium. The data transfer rate may be throttled, as described above, and further managed by tuning the number of buffers assigned to receive the Ethernet data. By tuning and throttling, process 40 provides relatively efficient data transfer with reduced data loss.

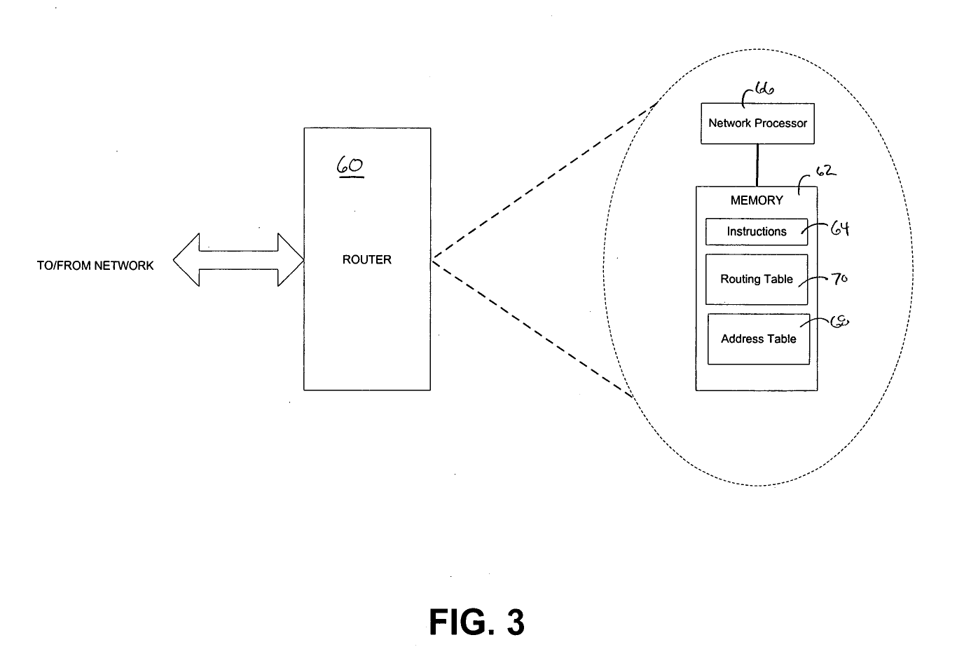

FIG. 3 shows an embodiment of a router 60 in which the network processor may be included. Router 60 includes a memory 62 for storing computer instructions 64, and a network processor 66 that contains circuitry 10 and performs process 40. Routing instructions 64 are executed by the network processor to cause network processor 11 to forward data packets in accordance with one or more routing protocols.

Memory 62 also stores an address table 68 and a routing table 70. In this regard, each device on a network has several associated addresses. For example, a device may have an address that includes a logical IP address of “200.10.1.1”, and a physical IP address of “192.115.65.12.

Routing table 70 stores network routing information, including logical Internet protocol (IP) addresses of devices on the network. Routing table 70 is used by routing instructions 64 to route packets. Address table 68 stores the physical IP addresses of network devices which map to corresponding logical IP addresses in routing table 70. These address tables are used by network processor 66, in particular the central processor therein, to route data packets to appropriate network addresses. Specifically, the central processor examines the packet headers of a received data packet, extracts a destination of the data packet from the packet heard, uses the routing and address tables to determine a “next hop” on the way to the destination, repackages the data packet, and forwards the data packet accordingly.

Process 40 not limited to use with the hardware and software of FIGS. 1 to 3; it may find applicability in any computing or processing environment.

Process 40 can be implemented in digital electronic circuitry, or in computer hardware, firmware, software, or in combinations of them. Process 40 can be implemented as a computer program product or other article of manufacture, e.g., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Process 40 can be performed by one or more programmable processors executing a computer program to perform functions. Process 40 can also be performed by, and apparatus of the process 40 can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

Process 40 can be implemented in a computing system that includes a back-end component, e.g., as a data server, or that includes a middleware component, e.g., an application server, or that includes a front-end component, e.g., a client computer having a graphical user interface or a Web browser, or any combination of such back-end, middleware, or front-end components.

The components of the system can be interconnected by any form or medium of digital data communication, e.g., a communication network. Examples of communication networks include a local area network (“LAN”) and a wide area network (WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Variations on the foregoing embodiments include, but are not limited to, the following. Process 40 may be used with hardware and/or software other than the hardware and software described herein. Consumer task 34 may be any type of software and is not limited to the functionality described herein. Replenisher task 36 may be tuned via any method including, but not limited to, those described above. The blocks of FIG. 2 may be rearranged and/or some of the blocks may be omitted to achieve a similar result.

Other embodiments not described herein are also within the scope of the following claims.

1. A method comprising:
assigning a buffer to hardware via a low priority task;
storing data in the buffer via the hardware;
passing the data from the buffer to a high priority task, the high priority task taking precedence over the low priority task in terms of processing resources; and
processing the data via the high priority task.

2. The method of claim 1, wherein the high priority task consumes processing resources such that there are not sufficient processing resources to run the low priority task.

3. The method of claim 1, wherein passing the data comprises passing the data through a software stack to the high priority task.

4. The method of claim 1, wherein assigning comprises assigning plural buffers to the hardware; and the method further comprises:
setting a number of the plural buffers.

5. The method of claim 1, wherein the buffer is part of a receive queue, the receive queue receiving the data for the hardware.

6. A method comprising:
executing a low priority task to replenish buffers; and
executing a high priority task to process data from the buffers, the high priority task taking precedence over the low priority task in terms of processor resources.

7. The method of claim 6, further comprising:
reading the data from the buffers; and
passing the data to the high priority task.

8. The method of claim 6, further comprising:
assigning a number of buffers to be replenished by the low priority task.

9. An apparatus comprising:
a processor to run a low priority task that assigns buffers to store data, and to run a high priority task that processes data from the buffers, the high priority task taking precedence over the low priority task; and
hardware to store the data in the buffers.

10. The apparatus of claim 9, wherein the high priority task consumes processor resources such that there is not sufficient processor resources to run the low priority task.

11. The apparatus of claim 9, wherein the processor runs a hardware access layer to pass the data through a software stack to the high priority task.

12. The apparatus of claim 9, wherein the low priority task assigns plural buffers, and the processor executes instructions to set a number of the plural buffers to be assigned.

13. The apparatus of claim 9, wherein the buffer is part of a receive queue, the receive queue receiving the data for the hardware.

14. An apparatus comprising:
a processor to execute a low priority task to replenish buffers, and to execute a high priority task to process data from the buffers, the high priority task taking precedence over the low priority task in terms of processor resources; and
hardware to store data in the buffers.

15. The apparatus of claim 14, wherein replenishing comprises assigning the buffers from a buffer pool.

16. The apparatus of claim 14, wherein the processor executes instructions to assign a number of buffers to be replenished by the low priority task.

17. An article comprising a machine-readable medium that stores instructions that cause a machine to:
execute a low priority task to replenish buffers; and
execute a high priority task to process data from the buffers, the high priority task taking precedence over the low priority task in terms of processor resources.

18. The article of claim 17, further comprising instructions that cause the machine to pass the data from the buffers to the high priority task.

19. The article of claim 17, further comprising instructions that cause the machine to:
assign a number of buffers to be replenished by the low priority task.

20. A router comprising:
a memory that stores routing tables; and
a network processor comprising:
a buffer queue comprised of buffers to store data packets;
a central processor to run a routing routine to process the data packets using the routing table, and to run a buffer replenishing task, the buffer replenishing task having a lower priority in terms of processor resources than the routing routine; and
a network processing engine to assign memory areas to the buffer queue in accordance with the buffer replenishing task.

21. The router of claim 20, wherein replenishing comprises assigning the memory areas to receive data.

22. The apparatus of claim 20, wherein the central processor executes instructions to assign a number of buffers to be replenished by the replenishing task.
